(19) United States
(12) Patent Application Publication
(10) Pub. No.: US 2002/0067948 A1
(43) Pub. Date: Jun. 6, 2002

(54) Writing and metering device

(76) Inventor: Martin Kuhn, Fluorn-Winzeln (DE)

Correspondence Address: NATH & ASSOCIATES PLLC, Sixth Floor, 1030 15th Street, N.W., Washington, DC, 20005, US

(21) Appl. No.: 09/987,451

(22) Filed: Nov. 14, 2001

(30) Foreign Application Priority Data
Nov. 17, 2000 (DE) 100 57 056.9

(51) Int. Cl. B43K 5/02

(52) U.S. Cl. 401/224; 401/223

(57) ABSTRACT

Writing and metering device with an ink supply chamber (22), an ink guide with a capillary ink regulator (20) and with a ventilation channel with a semi-permeable seal (30), a first non-capillary space (28) and a second non-capillary space (33). The second non-capillary space (33) is connected to the ink supply chamber (22) by at least one capillary (32a and/or 32b). To reduce ink losses a labyrinth vent (26) can additionally be provided in the ventilation channel.

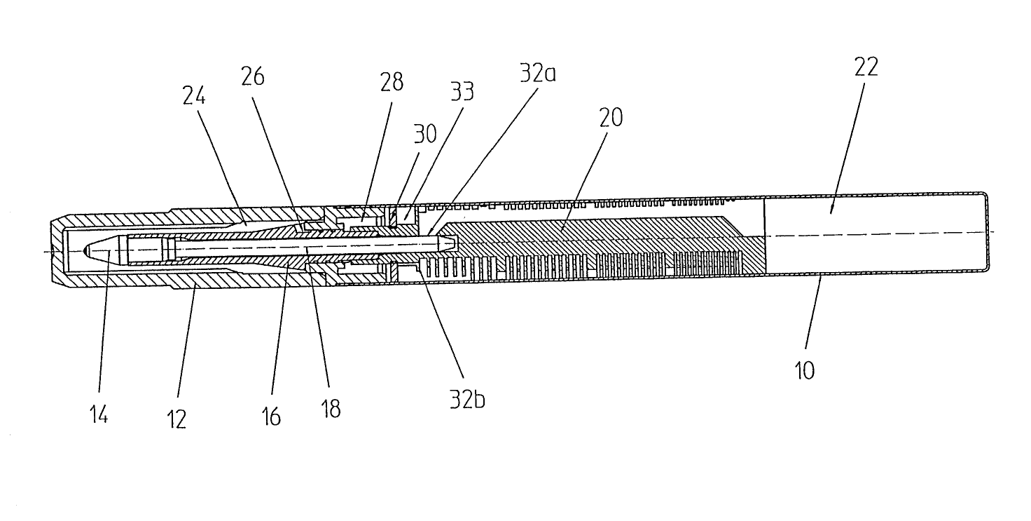

The invention relates to a writing and metering device according to the preamble of claim 1.

Such a device is known from GB 2 118 486 A. A semi-permeable seal and an adjoining non-capillary space at the front end of the ventilation channel are intended to serve as an anti-escape mechanism to prevent the escape of ink. Although the membrane-like seal prevents the escape of ink via the ventilation channel at this point it cannot prevent ink dripping via the writing tip following one or more large changes in pressure and/or temperature. This is because ink which escapes into the non-capillary space cannot be drawn back into the ink supply chamber. This results in an enclosed volume of air which can lead to leakage when there are large variations in pressure and/or temperature.

A device mentioned at the outset is intended to be improved by the invention in such a way that ink which has escaped under the influence of pressure and/or temperature is always drawn back into the ink supply chamber and a constant ventilation of the ink supply chamber is guaranteed.

This object is achieved according to the invention by the characteristics of claim 1. The arrangement of the semi-permeable seal within the writing device as well as of two non-capillary spaces in front of and behind the semi-permeable seal together with at least one capillary channel between the hindmost non-capillary space and the ink supply chamber results in unusually good security against leakage of ink. The capillary connection ensures that ink which has escaped behind the semi-permeable seal is drawn back into the ink supply chamber and that a constant ventilation of the ink supply chamber is guaranteed.

A labyrinth vent in the ventilation channel in front of the first non-capillary space and the semipermeable seal serves additionally to reduce ink losses when the writing device is stored with the cap removed.

The invention is described by way of example in more detail using the figure which shows a diagrammatic longitudinal section of a preferred embodiment of the writing and metering device according to the invention.

The writing and metering device represented has a housing 10 and a cap 12 which can be slipped onto the front end of the same. A writing tip 14 is connected, via a holder 16 and a writing wick 18 arranged in the holder 16, to a capillary ink regulator 20 and via the latter to an ink supply chamber 22 arranged at the rear end of the housing 10. The holder 16 is surrounded by a long front ventilation chamber 24 which is connected, via a labyrinth vent 26, to a first non-capillary space 28 and an adjoining semi-permeable seal 30 straddling the ventilation channel. The ink regulator 20 is connected to a second non-capillary space 33 via a capillary connection 32a and/or 32b so that any ink which has entered the second non-capillary space 33 is drawn back into the ink supply chamber 22. The labyrinth vent 26 additionally serves to reduce ink losses when the writing device is stored with the cap removed.

1. Writing and metering device with an ink supply chamber, an ink holder, with a capillary ink regulator, leading from the ink supply chamber to the writing wick, and with a ventilation channel connected to the ink supply chamber, a first non-capillary space and a semi-permeable seal which is impermeable to ink, characterized in that the first non-capillary space (28) and the semi-permeable seal (30) are connected, via a second non-capillary space (33) and the latter via at least one capillary (32a, 32b), to the ink supply chamber (22).

2. Writing and metering device according to claim 1, characterized in that a labyrinth vent (26) is provided in the ventilation channel.
